(19) United States
(12) Patent Application Publication
(10) Pub. No.: US 2008/0048494 A1
(43) Pub. Date: Feb. 28, 2008

(54) Delayed power supply crossing automobile/motocycle engine ignition time

(76) Inventor: Chen Kuan-Wei Hsieh, Taipei (TW)

Correspondence Address: BIRCH STEWART KOLASCH & BIRCH, PO BOX 747, FALLS CHURCH, VA, 22040-0747, US

(21) Appl. No.: 11/822,836

(22) Filed: Jul. 10, 2007

(30) Foreign Application Priority Data
Jul. 11, 2006 (TW) 095144282

(51) Int. Cl. F02P 9/00

(52) U.S. Cl. 307/10.6

(57) ABSTRACT

Automobile and motorcycle are not electrically stable during ignition process. This invention uses a simple delaying technique to allow delaying of the timing of secondary power supply for a prescribed time after crossing the unstable period of engine ignition period. In other words, delaying of supplying power could effectively increase the stability and safety of electrical equipment and prolong the usable life time of the electrical equipment.

### FIELD OF THE INVENTION

This invention is a simple method derived based on the consideration of safety usage of “vehicle electrical part”. It allows the delay device to control part of power supply output/input port. The power supply output/input port under control will not output/input power during ignition period but delays for a described t time before output/input power in anticipating the user has already started the engine successfully and power supply of the vehicle is already stable during this delayed period. Such method could avoid the engine generates unstable electrical current and impacting certain vehicle electrical equipment during the instant of starting engine.

### BACKGROUND OF THE INVENTION

Please refer to the prior art illustrated in FIG. 1. As shown in the figure, the key (05) of conventional vehicle must be put at the “ON” position (07). All electrical parts are receiving power at this time (LCD screen is turned on). User then turns the key into “START” position once to ignite the engine. The ignition coil creates strong electrical surge due to generation of tens of thousands of volts (the electrical components in the LCD screen suffers shock and jittering screen) before the key (05) bounces back to “ON” position (07). If the ignition is not successful, the key will be turned to “START” position repetitively, thus resulting in the electrical parts in the vehicle suffers several times of electrical shock. The electrical components inside could be damaged or life drastically reduced.

Once again please refer to the prior art illustrated in FIG. 2. As shown in the diagram, the car key (05) of conventional vehicle must be put at the “ON” position (07) first. At this time all circuits are conducting current. Again, pressing the starting button or foot starting paddle to start the engine. The ignition coil also requires tens of thousands of volts, thus creating strong electrical surge. If the starting is not successful, the ignition will have to be repeated, which could possibly create many times of electrical shock to the electronic components inside the vehicle (such as head light of conventional design). These electrical components could be damaged or burnt (such as burnt head light).

In summary, no matter automobile or motorcycle, car key must be placed at “ON” position before starting. At this time, the vehicle has already output power to electrical parts. The subsequent ignition procedure will generate electrical surge. To guarantee the safety of the sophisticate electrical parts, there is indeed a need to interrupt the supply of power during ignition process.

In view of the problem of above conventional arts, this invention proposes a kind of delayed power supply method across automobile and motorcycle in order to resolve the problem with prior arts.

### SUMMARY OF THE INVENTION

The main purpose of this invention is in providing a kind of delay power supply method used across automobile and motorcycle for the protection of the safety usage of the electrical devices inside the vehicle through delaying of supplying power by avoiding “unstable state during ignition”. The GPS used in automobile, in addition to the host computer, requires installation of receiver, LCD screen, and the related AV entertainment as well as information products. This invention makes use of delayed power supply in anticipation to achieve the purpose of protecting the electrical devices inside vehicle.

To achieve the above stated objective, please refer to FIG. 3 of this invention, which is the illustration showing the timing comparison between delayed power supply and engine ignition period. The electrical current of automobile and motorcycle is not stable during ignition period (engine ignition middle period 70 in FIG. 3). At this time, it is not suitable to supply power to electrical devices on the vehicle. This invention makes use of the method of simple delayed power supply (delaying the period of not outputting power 74: Vout=0) without supplying power to electrical devices, allowing the supply of power by a period of time after crossing the unstable period during ignition (power supplying period after the delay 75) before starting normal power supply (normal power supply period 76: Vout≠0) in order to increase the stability and safety of usage of electrical accessory devices and effectively extending the usable life time of electrical devices inside the vehicle.

### BRIEF DESCRIPTION OF THE DRAWINGS

[Prior Art Portion]

FIG. 1 Car key operating position sequence of prior art.

FIG. 2 Motorcycle key operating position sequence of prior art.

[Present Art Portion]

FIG. 3 Illustration of comparison between delayed power supply and engine power supply.

FIG. 4 Block diagram of delayed power supply configuration.

FIG. 5 Serial connection of delayed power supply of the cigarette lighter on automobile.

### DETAILED DESCRIPTION OF THE PREFERRED EMBODIMENTS

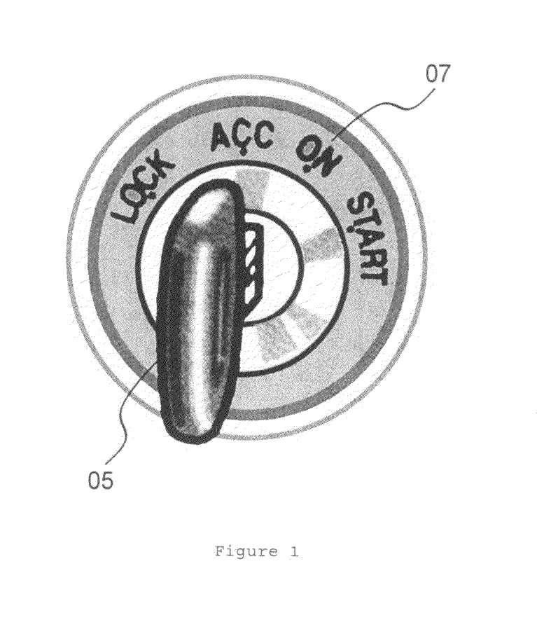

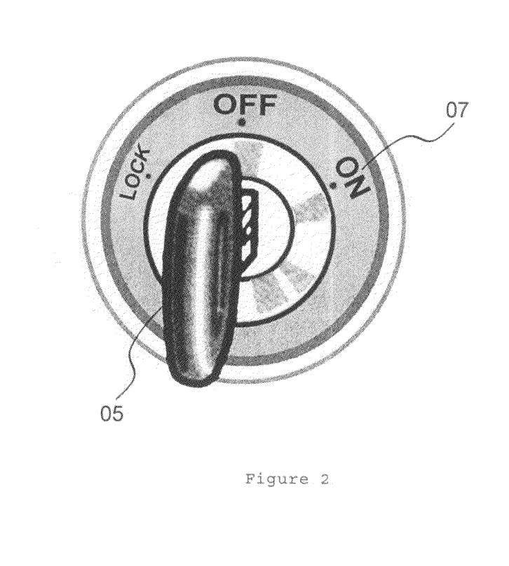

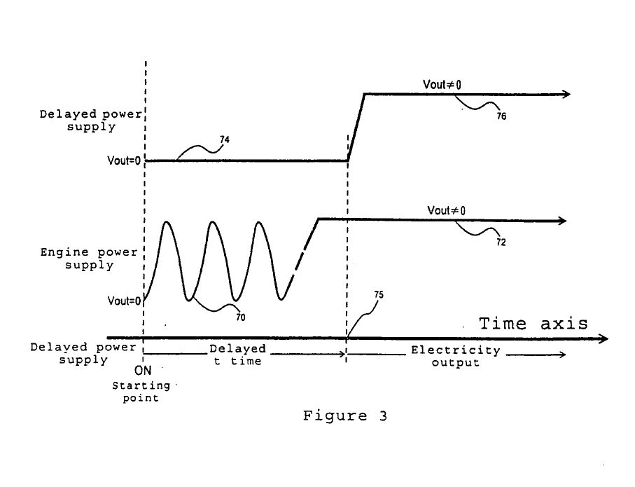

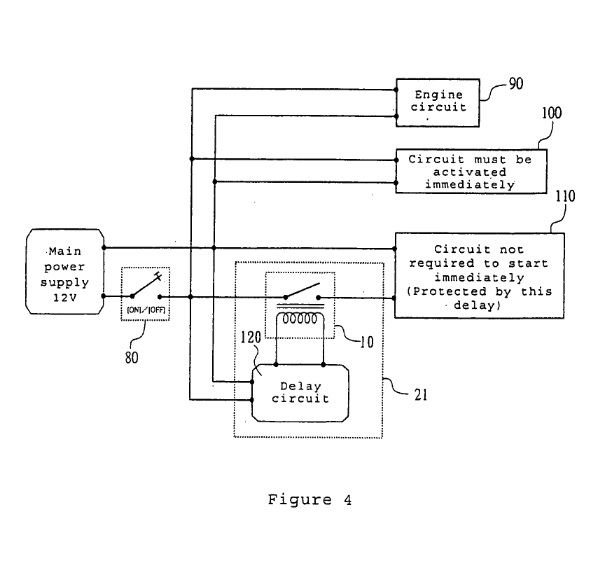

Please refer to FIG. 4 of this invention where the layout diagram of delayed power supply is illustrated. As shown in the illustration, the delayed power supply (21) contains two-portions including a delay circuit (120) and power supply circuit (10); whereas when the key of automobile or motorcycle is switched to “ON” position (80, of 07 in FIGS. 1 and 2), only power necessary is to be sent to required circuit (ignition circuit 90, and circuit 100 must be supplied immediately) in order for the user to start the engine, but the “circuit/electrical device not required to start immediately (110)” can be delayed a period of time t, t>0, through the delay circuit (120). After an anticipated time t, the power to be supplied to “circuit/electrical device not required to start immediately (110)” is activated. User is expected to ignite the engine smoothly during this t time (i.e. the delay of not outputting the power 74 in FIG. 3: Vout=0) and allows the generator to steadily rotate (engine operating period 72 in FIG. 3: Vout≠0) before the subsequent “circuit/electrical device not required to start immediately (110)” could receive the power supply circuit (10), thus achieves the purpose of protecting electrical devices.

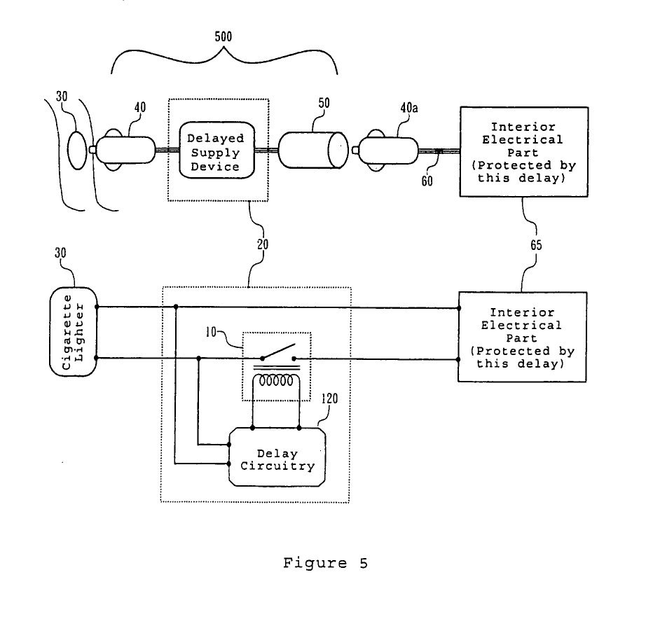

This “Delay of power supply for Automobile and motorcycle during ignition” has the following installation methods:
(1) The automobile/motorcycle circuit design can be included in the design by the automobile/motorcycle design, as shown in FIG. 4 which shows the configuration of delayed power supply device containing delayed circuit device (21) and shipped together with automobile/motorcycle.
(2) Design of this method into an external device that is attached to the existing circuit of automobile/motorcycle (if this device is added to the power supply circuit of the vehicle), as the delayed power supply circuit (21) in the delayed power supply configuration diagram shown in FIG. 4, which is installed onto the automobile/motorcycle after shipment of the automobile/motorcycle.
(3) A kind of simple method is for the user to connect the device to the “cigarette lighter” socket on the vehicle in series. Please refer to FIG. 5 which shows the serial structure (500) connection of connecting the delayed power supply device onto the cigarette lighter. As shown in the figure, this serial connection structure (500) is connecting a male connector (40) from the cigarette lighter to a female socket (50) to form an external device. A delayed power supply device (20) is installed between this male connector (40) and the female socket (50), which in turn allows the electrical devices (65) inside the vehicle to access the power from female socket (50) through connecting the male connector (40a) using wire (60).

In summary, this method is to block the power supply of the electrical device/circuit that needs protection during the ignition period of automobile and motorcycle so that the user could start the engine during this period, therefore allowing the electrical device/circuit to be connected subsequently could be protected from the damage of electrical surge. The delayed power supply device can be installed between a cigarette lighter male connector and female socket inside the vehicle, or included into the automobile/motorcycle circuit design. In this way, the delay time t can be automatically adjusted based on the engine temperature, state of mechanical parts, and detected data of electrical signal, and the time t, t>0, can also be programmed at a fixed value or adjusted manually.

What is claimed is:

1. A kind of delayed power supplying method crossing automobile and motorcycle engine ignition period, which consists of:
A main power supply, on the said main power supply a delayed power supply device is connected, which in turn connects to a circuit/electrical device not required to turn on immediately for supplying power, inside the said delayed power supply a delayed circuit is installed, when the main power supply is activated and passes through the said delayed circuit for t time the delayed power supply device will start to output power for the subsequent circuit/electrical device not required to start immediately for the protection of the circuit/electrical device inside the vehicle.

2. The delayed power supply method during ignition period crossing automobile and motorcycle as stated in claim 1, whereas the said delayed power supply device is an external added device, the said external added device is for the use of attaching to the existing electromechanical circuit of automobile and motorcycle.

3. The delayed power supply method during ignition period crossing automobile and motorcycle as stated in claim 1, whereas the said delayed power supply device is installed between a male connector of a car cigarette lighter and a female socket of a car cigarette lighter.

4. The delayed power supply method during ignition period crossing automobile and motorcycle as stated in claim 1, whereas the said delay time t is adjusted based on the engine temperature, state of mechanical parts, and electrical signal.

5. The delayed power supply method during ignition period crossing automobile and motorcycle as stated in claim 1, whereas the said delay time t is greater than zero.
